(19) United States
(12) Patent Application Publication
(10) Pub. No.: US 2014/0261891 A1
(43) Pub. Date: Sep. 18, 2014

(54) Cutting Knives, Systems And Methods For Forming A Predetermined Pattern Into A Wood Layer

(71) Applicant: Shaw Industries Group, Inc., Dalton, GA (US)

(72) Inventors: Robert Bryan Boggs, Greenville, SC (US); Michael Scott Standridge, Greer, SC (US); Jason Richard Shaw, Taylors, SC (US)

(73) Assignee: Shaw Industries Group, Inc., Dalton, GA (US)

(21) Appl. No.: 14/202,172

(22) Filed: Mar. 10, 2014

Related U.S. Application Data
(60) Provisional application No. 61/779,551, filed on Mar. 13, 2013.

(51) Int. Cl. B27L 5/02; B27M 1/00

(52) U.S. Cl. CPC B27L 5/02; B27M 1/003
USPC 144/358; 144/3.1; 144/212

(57) ABSTRACT

Implementations described herein comprise knives and cutting systems for forming a predetermined impression into a wood layer and methods associated therewith. In some aspects a cutting system comprises at least one knife, and a means for rotating the wood block about a rotation axis. Each knife of the at least one knife can have a cutting portion and a base portion, wherein the cutting portion comprises a cutting surface defining a pattern. The at least one knife can be operatively positioned relative to the wood block such that, upon rotation of the wood block about the rotation axis, the peripheral surface of the wood block is urged against the cutting surface of the at least one knife to form the wood layer and the pattern defined on the cutting surface of the at least one knife is configured to form the predetermined impression into the wood layer.

### CROSS-REFERENCE TO RELATED APPLICATION

This application claims the benefit of U.S. Provisional Application No. 61/779,551, filed Mar. 13, 2013, which is hereby incorporated herein by reference in its entirety.

### BACKGROUND

1. Field of the Invention

This invention relates to cutting knives, systems, and methods for forming a predetermined impression into a wood layer.

2. Related Art

Distressed wood flooring typically includes a plurality of planks distressed to make the planks look and feel as if the planks are aged. To give the planks a unique look and finish, the planks are typically hand-distressed or machine-distressed. However, hand-distressing a plank can be a time-consuming, labor-intensive job in which a skilled craftsman uses a variety of tools to individually distress each plank. Due to the amount of time and skill required to distress a plank by hand, hand-distressed planks can be prohibitively expensive.

Machines can be used to saw, sand and/or scrape planks to try and replicate a hand-distressed look without the need of a skilled craftsman. Machine-distressing of planks can be performed more quickly than hand-distressing. However, with conventional distressing machines, the “distressed” marks are made after the flooring plank has been created.

Thus, there is a need in the pertinent art for devices, systems, and methods that permit distressing of the planks in a cost-effective manner at an earlier stage in the process (prior to creation of the flooring planks)

### SUMMARY

Described herein is a cutting system for forming a predetermined impression into a wood layer. The wood layer can be obtained from a wood block using conventional methods. The wood block can have a peripheral surface. The cutting system can include at least one knife, with each knife having a cutting portion and a base portion. The cutting portion can have a cutting surface defining a pattern.

The cutting system also includes means for rotating the wood block about a rotation axis. For example, the means for rotating the wood block can be at least one spindle. Each spindle of the at least one spindle can be configured for engagement with the wood block, and each spindle of the at least one spindle can be configured for rotation about the rotation axis.

The at least one knife can be operatively positioned relative to the wood block (and the at least one spindle) such that upon rotation of the wood block (and the at least one spindle) about the rotation axis, the peripheral surface of the wood block is urged against the cutting surface of the at least one knife to form the wood layer. In operation, the pattern defined on the cutting surface of the at least one knife can form the predetermined impression into the wood layer as the wood block is urged into the cutting surface.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

The accompanying drawings, which are incorporated in and constitute a part of this specification, illustrate several aspects described below and together with the description, serve to explain the principles of the invention. Like numbers represent the same elements throughout the figures. The patent or application file contains at least one drawing executed in color. Copies of this patent or patent application publication with color drawing(s) will be provided by the Office upon request and the payment of the necessary fee.

FIG. 1 is a schematic diagram of a veneer peeling/slicing process.

FIG. 2 is an image of an exemplary template for placing a pattern of depression “flaws” into a knife as described herein.

FIG. 3 is an image of an exemplary pattern template in place on a knife as described herein.

FIG. 4 is an image of an exemplary Dremel tool for forming a pattern onto the cutting surface of a knife as described herein.

FIG. 5 is an image of an exemplary impression of “lathe lines” formed on a wood layer as described herein.

FIG. 6 is an image depicting the width of an exemplary impression of “lathe lines” formed on a wood layer as described herein.

FIG. 7 is an image of an exemplary wood layer having an impression as described herein.

FIG. 8 provides detailed front and side views of an exemplary cutting knife as described herein.

FIG. 9 displays an exemplary nose bar and knife assembly as described herein.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a wood layer” can include two or more such wood layers unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

Described herein with reference to FIGS. 1-9 are methods, devices, and systems for forming a predetermined impression into a wood layer 20 obtained from a wood block 10. In exemplary aspects, it is contemplated that the wood block 10 can be a log and the wood layer 20 can be a veneer layer. The wood block can have a peripheral surface 12.

In one aspect, a cutting system 100 can be used to form the predetermined impression 22 into the wood layer 20. In this aspect, the cutting system 100 can comprise at least one knife 30 and means for rotating the wood block 10 about a rotation axis 42. It is contemplated that each knife 30 of the at least one knife can have a cutting portion 32 and a base portion 36. It is further contemplated that the cutting portion can have a cutting surface 33 that defines a pattern 34. In exemplary aspects, the pattern 34 can be defined on an edge portion of the cutting surface 33.

In exemplary aspects, the at least one knife can have a hardness ranging from about 55 to about 60 and, more preferably, from about 56 to about 58, as measured on the Rockwell “C” hardness scale. In these aspects, it is contemplated that the at least one knife 30 can comprise S5 grade steel. It is further contemplated that the at least one knife 30 can comprise steel comprising from about 0.50% to about 0.65% carbon, from about 1.75% to about 2.25% silicon, from about 0.60% to about 1.0% manganese, less than about 0.03% phosphorous, less than about 0.03% sulfur, from about 0.10% to about 0.50% chromium, from about 0.20% to about 1.35% molybdenum, and from about 0.15% to about 0.35% vanadium.

In exemplary aspects, the means for rotating the wood block 10 about the rotation axis 42 can comprise at least one spindle 40. In these aspects, each spindle 40 of the at least one spindle can be configured for rotation about the rotation axis 42. In one aspect, each spindle 40 of the at least one spindle can be configured for engagement with the wood block 10. In exemplary aspects, the at least one knife 30 can be operatively positioned relative to the at least one spindle 40 such that, upon rotation of the wood block 10 (and the at least one spindle) about the rotation axis 42, the peripheral surface 12 of the wood block 10 is urged against the cutting surface 33 of the at least one knife to form the wood layer 20. In these aspects, it is contemplated that the pattern 34 defined on the cutting surface 33 of the at least one knife 30 can be configured to form the predetermined impression 22 into the wood layer 20.

In some aspects, it is contemplated that the at least one knife 30 can be configured to remain stationary as the wood block 10 is urged against the cutting surface 33. In other aspects, it is contemplated that the at least one knife 30 can be configured for selective movement relative to the wood block 10 using conventional methods. In these aspects, it is contemplated that the at least one knife can be secured within a knife carriage (not shown) that is selectively moveable relative to the wood block, such as, for example and without limitation, a knife carriage as disclosed in U.S. Pat. No. 7,337,813, which is incorporated by reference herein in its entirety. It is further contemplated that the at least one knife can be selectively moveable into the peripheral surface 12 of the wood block 10 as the wood block is rotated about the rotation axis 42.

Optionally, in alternative aspects, it is contemplated that the means for rotating the wood block 10 about the rotation axis 42 can comprise one or more rollers as are conventionally known in the art, such as, for example and without limitation, the rollers of the spindleless veneer lathe disclosed in U.S. Pat. No. 5,787,949, which is incorporated by reference herein in its entirety. In other alternative aspects, it is contemplated that the means for rotating the wood block 10 about the rotation axis 42 can comprise one or more peripheral drive members for rotationally driving a wood block as are conventionally known in the art, such as, for example and without limitation, the peripheral drive system disclosed in U.S. Pat. No. 7,337,813, which is incorporated by reference herein in its entirety. However, it is contemplated that the means for rotating the wood block about the rotation axis can comprise any conventional mechanism for rotating a wood block in a controlled manner.

In various aspects and in reference to at least FIG. 9, it is contemplated that the means for rotating the wood block 10 can further comprise a nose bar 60 that is configured to compress the wood layer 20 ahead and behind of the cutting surface 33 of the at least one knife as is conventionally known in the art. In these aspects, it is contemplated that the nose bar 60 can be supported by a nose bar beam 62 as is conventionally known in the art. It is contemplated that the nose bar can be any conventional nose bar, such as, for example and without limitation, the nose bar disclosed in U.S. Pat. No. 6,772,809, which is incorporated by reference herein in its entirety.

In one exemplary aspect and in reference to at least FIGS. 5-8, the pattern 34 defined on the cutting surface 33 of the at least one knife 30 can comprise a plurality of spaced notches 35. In this aspect, it is contemplated that the plurality of spaced notches 35 can optionally comprise a plurality of substantially parallel notches. In some aspects, the spacing between the notches 35 can vary along the longitudinal length of the at least one knife 30. It is further contemplated that the predetermined impression 22 formed into the wood layer 20 can comprise a plurality of spaced lines 24. It is still further contemplated that the plurality of spaced lines 24 can optionally comprise a plurality of substantially parallel lines. In exemplary aspects, the plurality of spaced lines 24 function as a plurality of “lathe lines” that produce a distressed appearance on the wood layer 20.

In exemplary aspects, it is contemplated that each notch 35 of the plurality of notches of the at least one knife 30 can have a depth ranging from about 0.025 inches to about 0.040 inches. It is further contemplated that the depth of each notch 35 can be substantially equal to the height of the corresponding portion of the impression and markings formed into the wood layer 20. In additional exemplary aspects, it is contemplated that each notch 35 of the plurality of notches of the at least one knife 30 can have a width of less than 0.1 inches, and, more preferably, ranging from about 0.045 inches to about 0.060 inches. It is further contemplated that the width of each notch 35 can be substantially equal to the width of the corresponding portion of the impression and markings formed in the wood layer 20 (and the space between the resulting projections on the wood layer). For example, when the predetermined impression 22 is a plurality of spaced lines 24, each line formed on the wood layer 20 can have a width that is substantially equal to the width of the corresponding notch 35 of the at least one knife 30.

In another exemplary aspect, the pattern 34 defined on the cutting surface 33 of the at least one knife 30 can comprise one or more predetermined shapes. In this aspect, it is contemplated that at least one shape of the one or more predetermined shapes can be selected from the group consisting of a substantially rectangular shape, a substantially square shape, a substantially circular shape, a substantially oval shape, and an arcuate shape. It is contemplated that the notches and shaped patterns disclosed herein are merely exemplary of the many patterns 34 that can be formed at the cutting surface 33 of the at least one knife 30 to form a predetermined impression and series of markings on a wood layer as disclosed herein. Thus, it is contemplated that any cutting surface pattern that can produce a desired visual appearance on a surface of the wood layer 20 can be formed into the at least one knife. In exemplary aspects, it is contemplated that at least portions of the pattern 34 can be angled relative to the edge of the cutting surface 33.

In an additional aspect, the cutting system 100 can further comprise means for controlling the rotation of the wood block 10 about the rotation axis 42. It is contemplated that the means for controlling the rotation of the wood block 10 can comprise any conventional control systems for controlling the operation of the disclosed means for rotating the wood block. In exemplary aspects, the means for controlling the rotation of the wood block can comprise a control unit in operative communication with a motor that is operatively coupled to a spindle, peripheral drive member, or a roller as disclosed herein for purposes of imparting rotational motion. In these aspects, it is contemplated that the control unit can be any conventional control unit for veneer cutting operations, including, for example and without limitation, the control units disclosed in U.S. Pat. Nos. 5,787,949, 6,772,809, and U.S. Pat. No. 7,337,813, each of which is incorporated herein by reference in its entirety. In cutting systems 100 in which the at least one knife 30 is selectively moveable relative to the wood block 10, it is further contemplated that the control unit can be in operative communication with a motor that is operatively coupled to the at least one knife (or knife carriage) such that the position and/or angular orientation of the at least one knife can be controlled by selective activation of the motor. It is contemplated that the control unit can be configured to selectively control a feed rate of the cutting system 100 based upon one or more of the rate of rotation of the wood block, the position and/or movement of the at least one knife, and the diameter of the wood block.

In one aspect and with reference to at least FIG. 8, each knife 30 of the at least one knife can have a longitudinal axis 38 and a transverse axis 39. In this aspect, the longitudinal axis 38 of each knife 30 can be substantially parallel to the rotation axis 42 of the at least one spindle 40, and the transverse axis 39 of each knife 30 can be substantially perpendicular to the rotation axis of the at least one spindle. In exemplary aspects, the cutting surface 33 of each knife 30 of the at least one knife can be sloped at a selected angle 37 relative to the transverse axis 39. In these aspects, the selected angle 37 can range from about 15 to about 25 degrees and, more preferably, can be about 21 degrees. In exemplary aspects, each knife of the at least one knife 30 can have a longitudinal length (extending parallel to the longitudinal axis 38) ranging from about 40 inches to about 70 inches and, more preferably, ranging from about 50 inches to about 60 inches. In these aspects, it is contemplated that each knife of the at least one knife 30 can have a width (extending parallel to the transverse axis 39) ranging from about 5 inches to about 10 inches and, more preferably, ranging from about 7 inches to about 8 inches. It is further contemplated that each knife of the at least one knife 30 can have a thickness ranging from about 0.25 inches to about 1 inch and, more preferably, ranging from about 0.5 inches to about 0.75 inches. In one exemplary aspect, each knife of the at least one knife 30 can have a longitudinal length of about 54 inches, a width of about 7.5 inches, and a thickness of about 0.625 inches. In additional exemplary aspects, it is contemplated that the outer edge surfaces of each knife 30 of the at least one knife can be inwardly tapered moving along the transverse axis 39 from the cutting surface of the knife toward the base portion of the knife.

It is contemplated that the particular dimensions and orientation of the at least one knife 30 can vary significantly depending upon the particular lathe and/or other system components that are used. For example, it is contemplated that the angular orientation of the at least one knife, the bevel length (at the cutting edge of the at least one knife), the angle of the nose bar, and the dimensions and horizontal and vertical positioning of the at least one knife can be selectively varied to achieve optimal performance with other system components.

In use, the disclosed cutting systems can be used to form a predetermined impression into a wood layer. The wood layer can be obtained from a wood block. Typically, the wood block is soaked in vats at a desired temperature for a predetermined time period. After soaking, the at least one knife can be operatively positioned relative to the wood block. In one aspect, the wood block can be rotated about a rotation axis such that the peripheral surface of the wood block is urged against the cutting surface of the at least one knife, thereby forming the wood layer. In this aspect, the pattern defined on the cutting surface of the at least one knife can form the predetermined impression into the wood layer as the peripheral surface of the wood block is urged against the cutting surface. It is contemplated that the at least one knife can be angled and positioned in a desired orientation such that the wood layer has a desired thickness. In exemplary aspects, the step of operatively positioning the at least one knife relative to the wood block can comprise positioning the wood block in engagement with the at least one spindle. In these aspects, each spindle of the at least one spindle can be rotated about the rotation axis such that the peripheral surface of the wood block is urged against the cutting surface of at least one knife, thereby forming the wood layer.

In order to use the device, in one aspect, the feed speed for the turning of the veneer log can be set to a desired speed. The veneer knife can be positioned in a desired position so that the veneer knife exerts a desired pressure on the veneer log, urging the veneer log toward the veneer knife. At least a portion of the veneer knife, such as the depressed pattern, can contact the turning veneer log. The portion of the veneer knife contacting the veneer log can slice the predetermined impression into the veneer ribbon. The veneer ribbon gets clipped, dried and moves on through the process.

After the wood layer is formed, the wood layer can be clipped to a desired length. After the dimensions of the wood layer are properly adjusted, the wood layer can be dried to a desired moisture content and processed using conventional processing steps.

### Forming of the Pattern in the Cutting Surface

It is contemplated that any known means for shaping and/or modifying a wood cutting knife can be used to form the pattern into the at least one knife 30. In some aspects, the at least one knife 30 can be modified to define the pattern 34. In these aspects, the pattern 34 is formed into the at least one knife 30 in a separate step from the formation of the at least one knife. For example, the at least one knife 30 can initially be provided to a user without the pattern 34; after the user receives the at least one knife, the user can selectively form a user-defined pattern into the at least one knife. In exemplary aspects and with reference to at least FIG. 4, the pattern 34 can be formed into the at least one knife 30 using one or more grinding tools, such as, for example and without limitation, a Dremel tool having Dremel grinding discs. In these aspects, it is contemplated that the grinding discs can be configured to rotate as the grinding discs contact the at least one knife. It is further contemplated that the diameter and thickness of the grinding discs can be selected depending upon the dimensions of the pattern to be formed into the at least one knife. In use, the rotating disc can be lowered to a position closer to the at least one knife so that a force is exerted on a selected portion of the veneer knife, thereby forming a notch in an edge portion of the cutting surface of the at least one knife. It is contemplated that the edge portion of the cutting surface can be configured to exert a force onto the wood block such that the predetermined impression is formed on the wood layer as described herein.

In exemplary aspects and with reference to at least FIGS. 2-3, the formation of the pattern 34 can be guided by one or more templates 50, which are provided with markings 52 corresponding to the position of notches or other elements of pattern to be formed in the at least one knife In these aspects, the template 50 can be positioned in spaced relation to the edge portion of the cutting surface of the at least one knife such that a rotating grinding disc can be aligned with a particular marking 52 of the template. It is contemplated that the templates 50 can be labeled such that users can track the particular markings 52 that are used to apply a selected pattern 34 to a respective knife 30. It is further contemplated that, in the event of damage to a portion of a knife, a template 50 can be used to ensure that the knife is re-patterned in a consistent manner to the remaining portions of the knife.

Alternatively, in other aspects, the at least one knife 30 can be formed to have the pattern 34. In these aspects, the pattern 34 can be formed into the at least one knife 30 concurrently with the formation of the at least one knife. The pattern 34 can be formed into the at least one knife 30 using conventional knife shaping methods. In exemplary aspects, the pattern can be formed into the edge portion of the cutting surface of the at least one knife. In these aspects, it is contemplated that the edge portion of the cutting surface can be configured to exert a force onto the wood block such that the predetermined impression is formed on the wood layer as described herein.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A cutting system for forming a predetermined impression into a wood layer obtained from a wood block, the wood block having a peripheral surface, the cutting system comprising:
at least one knife, each knife of the at least one knife having a cutting portion and a base portion, the cutting portion having a cutting surface defining a pattern; and
means for rotating the wood block about a rotation axis,
wherein the at least one knife is operatively positioned relative to the wood block such that upon rotation of the wood block about the rotation axis, the peripheral surface of the wood block is urged against the cutting surface of the at least one knife to form the wood layer, and
wherein the pattern defined on the cutting surface of the at least one knife is configured to form the predetermined impression into the wood layer.

2. The cutting system of claim 1, wherein the pattern defined on the cutting surface of the at least one knife comprises a plurality of spaced notches.

3. The cutting system of claim 2, wherein the plurality of spaced notches comprises a plurality of substantially parallel notches.

4. The cutting system of claim 2, wherein the predetermined impression formed into the wood layer comprises a plurality of spaced lines.

5. The cutting system of claim 4, wherein the predetermined impression formed into the wood layer comprises a plurality of substantially parallel lines.

6. The cutting system of claim 1, wherein the pattern defined on the cutting surface of the at least one knife comprises one or more predetermined shapes.

7. The cutting system of claim 6, wherein at least one shape of the one or more predetermined shapes is selected from the group consisting of a substantially rectangular shape, a substantially square shape, a substantially circular shape, a substantially oval shape, and an arcuate shape.

8. The cutting system of claim 1, wherein the wood layer obtained from the wood block comprises a veneer layer.

9. The cutting system of claim 8, further comprising means for controlling the rotation of the wood block about the rotation axis.

10. The cutting system of claim 1, wherein each knife of the at least one knife is stationary.

11. The cutting system of claim 1, wherein each knife of the at least one knife has longitudinal axis and a transverse axis, wherein the longitudinal axis is substantially parallel to the rotation axis of the at least one spindle, and wherein the transverse axis of each knife is substantially perpendicular to the rotation axis of the at least one spindle.

12. The cutting system of claim 11, wherein the cutting surface of each knife of the at least one knife is sloped at a selected angle relative to the transverse axis.

13. The cutting system of claim 1, wherein the at least one knife has a hardness ranging from 55 to 60 on the Rockwell “C” hardness scale.

14. The cutting system of claim 1, wherein the means for rotating the wood block comprise at least one spindle, each spindle of the at least one spindle being configured for engagement with the wood block, each spindle of the at least one spindle being further configured for rotation about the rotation axis

15. A knife for forming a predetermined impression into a wood layer, the wood layer being formed by urging a wood block into the knife, the knife comprising:
a cutting portion having a cutting surface defining a pattern; and
a base portion,
wherein the pattern defined on the cutting surface is configured to form the predetermined impression into the wood layer.

16. The knife of claim 15, wherein the pattern defined on the cutting surface comprises a plurality of spaced notches.

17. The knife of claim 16, wherein the plurality of spaced notches comprises a plurality of substantially parallel notches.

18. The knife of claim 15, wherein the pattern defined on the cutting surface comprises one or more predetermined shapes.

19. The knife of claim 18, wherein at least one shape of the one or more predetermined shapes is selected from the group consisting of a substantially rectangular shape, a substantially square shape, a substantially circular shape, a substantially oval shape, and an arcuate shape.

20. A method for forming a predetermined impression into a wood layer obtained from a wood block, the wood block having a peripheral surface, comprising:
operatively positioning the wood block relative to at least one knife;
rotating the wood block about a rotation axis such that the peripheral surface of the wood block is urged against a cutting surface of the at least one knife, thereby forming the wood layer,
wherein the cutting portion of each knife of the at least one knife has a cutting surface defining a pattern, and
wherein the pattern defined on the cutting surface of the at least one knife is configured to form the predetermined impression into the wood layer.
